(19) United States
(12) Patent Application Publication
(10) Pub. No.: US 2025/0067706 A1
(43) Pub. Date: Feb. 27, 2025

(54) ELECTROPHORESIS SYSTEM

(71) Applicant: HITACHI HIGH-TECH CORPORATION, Tokyo (JP)

(72) Inventors: Ayaka OKUNO, Tokyo (JP); Hitoshi MIYATA, Tokyo (JP); Ryusuke KIMURA, Tokyo (JP); Motohiro YAMAZAKI, Tokyo (JP); Shuhei YAMAMOTO, Tokyo (JP); Michiru FUJIOKA, Tokyo (JP)

(21) Appl. No.: 18/723,618

(22) PCT Filed: Jan. 20, 2022
(86) PCT No.: PCT/JP2022/001880

§ 371 Date: Jun. 24, 2024

(51) Int. Cl. G01N 27/447

(52) U.S. Cl. CPC G01N 27/44704

(57) ABSTRACT

An object of the disclosure is to provide an electrophoresis system capable of suppressing recurrence of a carry-over as a result of washing of a capillary. The electrophoresis system according to the disclosure is configured to cause the sample stage to reduce the carry-over which is caused by the sample remaining in the washing container after introduction of the sample into a first capillary out of a plurality of capillaries, and influences analysis of the sample using a second capillary out of a plurality of capillaries (see FIG. 5).

### TECHNICAL FIELD

The disclosure relates to an electrophoresis system for analyzing samples by electrophoresis.

### BACKGROUND ART

Multi-capillary electrophoresis apparatuses have been widely used, each of which is configured to fill a plurality capillaries with electrolyte solutions or electrolyte solutions containing polymer gels and polymers so that electrophoretic analysis is performed in parallel. An electrophoretic analysis target is diversified from the low molecular substance to the high molecular substance such as a protein and a nucleic acid. There are many modes for measurement, which include a mode in which an absorption point of each capillary is irradiated with the lamp light to detect absorption of the lamp light generated when the analysis target passes the absorption point, or a mode in which a light emitting point of each capillary is irradiated with a laser light to detect a fluorescence light or a scattered light generated when the analysis target passes the light emitting point. Recently, the electrophoresis method that attains especially the high dynamic range and the high densification has been demanded.

In the case of the electrophoresis system using the capillary, mixture of light emitting signals may occur among a plurality of capillaries. Such phenomenon is called a spatial crosstalk. After executing electrophoresis of a sample in a specific capillary, the sample remaining in the capillary for the previous electrophoresis may interfere with acquisition of an accurate light emitting signal from another electrophoresis subsequent to the previous electrophoresis. Such phenomenon is called carry-over.

Patent Literature 1 as below discloses the technique for suppressing the spatial crosstalk. In the document disclosing the technique, the electrophoresis system is proposed as described below. Specifically, the electrophoresis system is provided with an electrophoresis apparatus and a computer for controlling the electrophoresis apparatus. The electrophoresis apparatus includes a plurality of capillaries in which electrophoresis of the sample is executed, a light source for irradiating a detection position of the capillary with light, a detector for detecting the sample-component-dependent light generated by irradiation of light from the light source, a buffer storage section that stores a buffer, having each one end of a plurality of capillaries taken in/out upon electrophoresis of the sample. The computer controls each electrophoresis condition for the respective capillaries of the electrophoresis apparatus so that each time taken for the component migrating in the capillary to reach the detection position becomes different. This makes it possible to detect the fluorescence signal at timings which differ by the respective capillaries of the electrophoresis apparatus (FIG. 4) (see Abstract).

In order to suppress the carry-over, it is effective to execute the process of washing the capillary. Patent Literature 2 as below discloses an example of the washing process as described below. The capillary electrophoresis apparatus 1 stops application of the high voltage. Upon completion of introduction of the sample into the separation medium in a capillary 31, an auto sampler unit 60 moves a table 61 to move an well 71 of a sample plate 73 from a sample introduction end 31a of the capillary 31. Then an washing water container 92 is moved to the array position to immerse the end of the capillary 31 at the sample introduction side in the washing water. The sample liquid adhered to the sample introduction end 31a, and the outer surface of the conductive member tube 32 is removed (S130) (see paragraph 0070).

### CITATION LIST

### Patent Literature

Patent Literature 1: WO2021/210144 A1
Patent Literature 2: Japanese Unexamined Patent Application Publication No. 2009-042226

### SUMMARY OF INVENTION

### Technical Problem

As disclosed in Patent Literature 2, it is considered that washing of the end of the capillary at the sample introduction side allows suppression of the carry-over to a certain extent. On the other hand, the washing process may contaminate the washing tank. In this case, even if the washing process is executed in the subsequent measurement, the contaminated washing bath may cause another carry-over. The recurrence of carry-over owing to the contaminated washing bath may occur in the course of measurement. The technique disclosed in Patent Literature 2 fails to sufficiently cope with this problem.

The carry-over may influence the process for suppressing the spatial crosstalk as disclosed in Patent Literature 1. In Patent Literature 1, electrophoresis is controlled so that the time taken for the component in the first capillary to reach the detection position differs from the time taken for the component in the second capillary to reach the detection position (see claim 1 of the document). The above control is executed for the reason as described below. When acquiring the measurement signal from the second capillary, the signal peak of the carry-over from the first capillary may overlap with the signal peak of the spatial crosstalk from the second capillary on the time axis.

The present disclosure is made considering the problem as described above. It is an object of the present disclosure to provide the electrophoresis system capable of suppressing recurrence of carry-over caused by washing of the capillary.

### Solution to Problem

The electrophoresis system according to the disclosure is configured to cause the sample stage to reduce the carry-over which is caused by the sample remaining in the washing container after its introduction into a first capillary out of a plurality of capillaries, and influences analysis of the sample using a second capillary out of a plurality of capillaries.

### Advantageous Effects of Invention

The electrophoresis system according to the disclosure allows suppression of recurrence of carry-over caused by washing of the capillary. Other structures, problems and advantageous effects are clarified by explanations of an embodiment described below.

### BRIEF DESCRIPTION OF DRAWINGS

FIG. 1 shows a configuration of an electrophoresis system 1 according to a first embodiment.

FIG. 2 shows a graph representing an example of carry-over.

FIG. 3 is a plan view illustrating an exemplary method for suppressing a spatial crosstalk as disclosed in Patent Literature 1.

FIG. 4 illustrates an example that the peak of the carry-over signal overlaps with the peak of the spatial crosstalk signal on the time axis.

FIG. 5 illustrates a method for suppressing the carry-over as described in a first embodiment.

FIG. 6 illustrates another method for suppressing the carry-over as described in the first embodiment.

FIG. 7 illustrates another method for suppressing the carry-over as described in the first embodiment.

FIG. 8 illustrates another method for suppressing the carry-over as described in the first embodiment.

FIG. 9 illustrates another method for suppressing the carry-over as described in the first embodiment.

FIG. 10 shows graphs each indicating a verification result with respect to the effect for suppressing the carry-over as described in the first embodiment.

FIG. 11 shows graphs each indicating a verification result with respect to the effect for suppressing the carry-over as described in the first embodiment.

FIG. 12 is a timing chart of the respective processes upon incorporation of the carry-over suppressing procedure into the normal measurement process.

FIG. 13 is a timing chart of the respective processes upon incorporation of the carry-over suppressing procedure into the calibration process for suppressing the spatial crosstalk.

### DESCRIPTION OF EMBODIMENTS

### First Embodiment: System Configuration

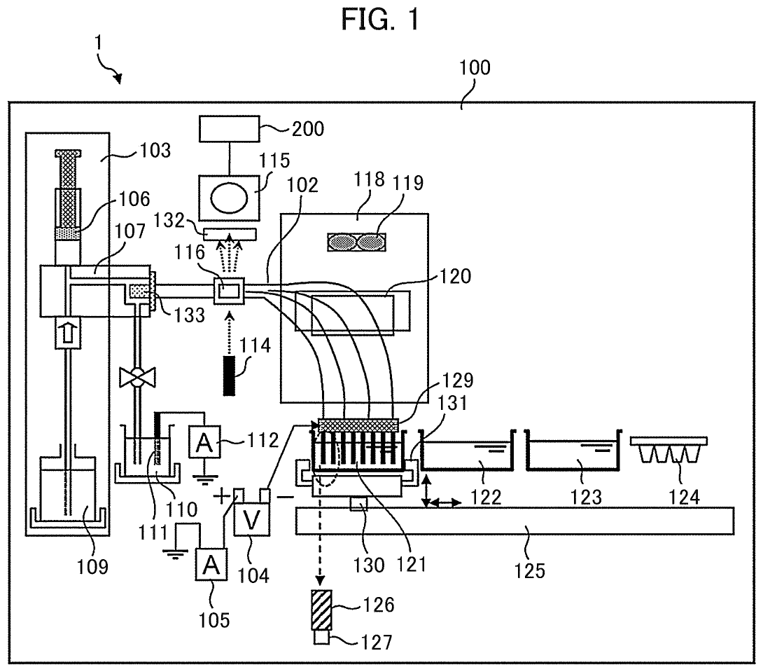

FIG. 1 shows a configuration of an electrophoresis system 1 according to a first embodiment of the disclosure. The electrophoresis system 1 includes an electrophoresis apparatus 100 and an arithmetic operation device 200 (computer). The electrophoresis apparatus 100 analyzes a component of a sample electrophoresed in the capillary.

The electrophoresis apparatus 100 includes a detection section 116, a thermostat bath 118, a transporting unit 125, a high voltage power supply 104, a first ammeter 105, a second ammeter 112, a capillary 102, and a pump mechanism 103. The detection section 116 optically detects the sample. The thermostat bath 118 keeps the capillary 102 at a constant temperature. The transporting unit 125 transports various containers to a negative electrode end of the capillary. The high voltage power supply 104 applies high voltage to the capillary 102. The first ammeter 105 measures the current output from the high voltage power supply 104. The second ammeter 112 measures the current applied through a positive electrode 111. The pump mechanism 103 injects a polymer into the capillary 102.

The capillary 102 is formed of a glass tube having an internal diameter from several tens to several hundreds microns, and an external diameter of several hundreds microns, and has its surface coated with polyimide for improving the strength. The polyimide coating applied to a photoirradiation section to be irradiated with the laser light is removed to facilitate leakage of the internal light emission to the outside. The inside of the capillary 102 is filled with a separation medium for making the electrophoretic speed different upon electrophoresis. The separation medium may be of fluidity type and non-fluidity type. In the first embodiment, the polymer of fluidity type is employed.

The detection section 116 forms a part of a region of the capillary 102. When the detection section 116 is irradiated with an excitation light ray from a light source 114, a fluorescence having a sample-dependent wavelength (hereinafter referred to as information light) is emitted from the sample, and released to the outside of the capillary 102. The information light is divided in the wavelength direction by a diffraction grating 132. An optical detector 115 detects the divided information light for analysis of the sample.

A capillary negative electrode end 127 is fixed through a metal hollow electrode 126. A leading end of the capillary protrudes from the hollow electrode 126 by approximately 0.5 mm. All the hollow electrodes 126 provided for the respective capillaries are integrated to be fitted with a load header 129. All the hollow electrodes 126 are conducted with the high voltage power supply 104 installed in an apparatus body, and serve as negative electrodes when voltage application is necessary for electrophoresis and introduction of the sample.

A capillary head 133 bundles the respective capillary ends (the other ends) opposite to the capillary negative electrode end 127 into one. The capillary head 133 can be connected to a block 107 air tightly with pressure resistance. The high voltage output from the high voltage power supply 104 is applied between the load header 129 and the capillary head 133. A syringe 106 fills the inside of the capillary with a new polymer from the other end. The polymer is refilled to the inside of the capillary in every measurement for improving the measurement performance.

The pump mechanism 103 includes the syringe 106, and a mechanical system for pressurizing the syringe 106. The block 107 is a connection member for communicating the syringe 106, the capillary 102, a positive electrode buffer container 110, and a polymer container 109 with one another.

The optical detection section for detecting the information light from the sample includes the light source 114, the optical detector 115 for detecting light emission in the detection section 116, and the diffraction grating 132. When detecting the sample in the capillary, which has been separated through electrophoresis, the detection section 116 of the capillary is irradiated by the light source 114, and the light emitted from the detection section 116 is divided by the diffraction grating 132 to allow the optical detector 115 to detect the divided information light.

The thermostat bath 118 is covered with a thermal insulation material for keeping the inside at the constant temperature. A heating-cooling mechanism 120 executes temperature control operations. A fan 119 circulates and agitates air in the thermostat bath 118 to keep the capillary 102 at the positionally uniform and constant temperature.

The transporting unit 125 includes three units of electric motors and linear actuators at the maximum to attain mobility along three axes at the maximum, including up-down, left-right, and depth directions. A stage 130 on the transporting unit 125 allows at least one or more containers to be placed thereon. The stage 130 is provided with an electric grip 131 which allows a user to grip or release the respective containers. This makes it possible to transport the buffer container 121, a washing container 122, a waste liquid container 123, and a sample container 124 to the capillary negative electrode end 127 as needed. An unnecessary container is stored in a predetermined storage section within the apparatus. The buffer container 121 and the washing container 122 may be collectively referred to as a “buffer storage section”.

The arithmetic operation device 200 executes processes of acquiring the detection result of the information light from the optical detector 115, analyzing the detection result to generate a fluorescence intensity waveform to be described later, and calculating a base length of a measurement target substance. Details of processes executed by the arithmetic operation device 200, and other components shown in FIG. 1 are described later. The arithmetic operation device 200 may be constituted by a Central Processing Unit (CPU), and a software to be executed by the CPU, or a hardware such as a circuit device for implementing the similar functions.

### First Embodiment: Problems of Prior Art

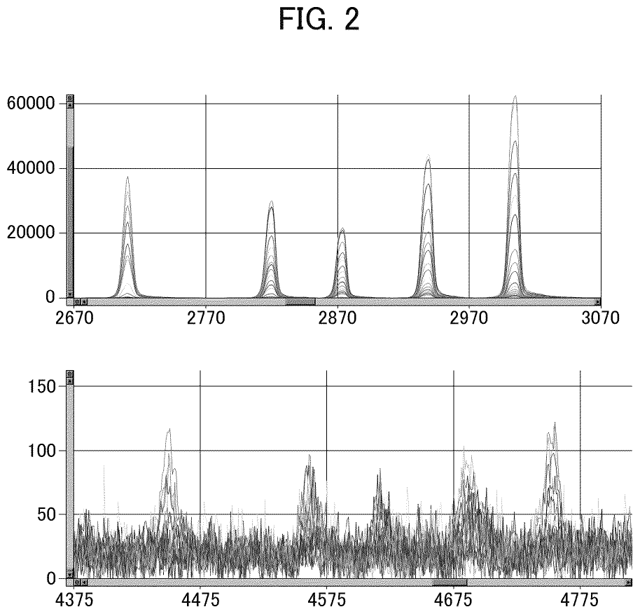

FIG. 2 shows a graph representing an example of carry-over. As described in the paragraph 0070 of Patent Literature 2, the leading end of the capillary is immersed in the washing container 122 so that the carry-over can be suppressed to a certain degree. The washing operation, however, may contaminate the inside of the washing container 122. In the above-described case, subsequent immersion of the leading end of the capillary in the washing container 122 results in recurrence of a carry-over owing to the contaminated washing container 122. The recurred carry-over reaches the level corresponding to about 0.3% of the fluorescence signal peak in the last measurement. This may become a factor of interfering with the accurate measurement of the fluorescence signal peak. For this reason, it is required to suppress contamination of the washing container 122.

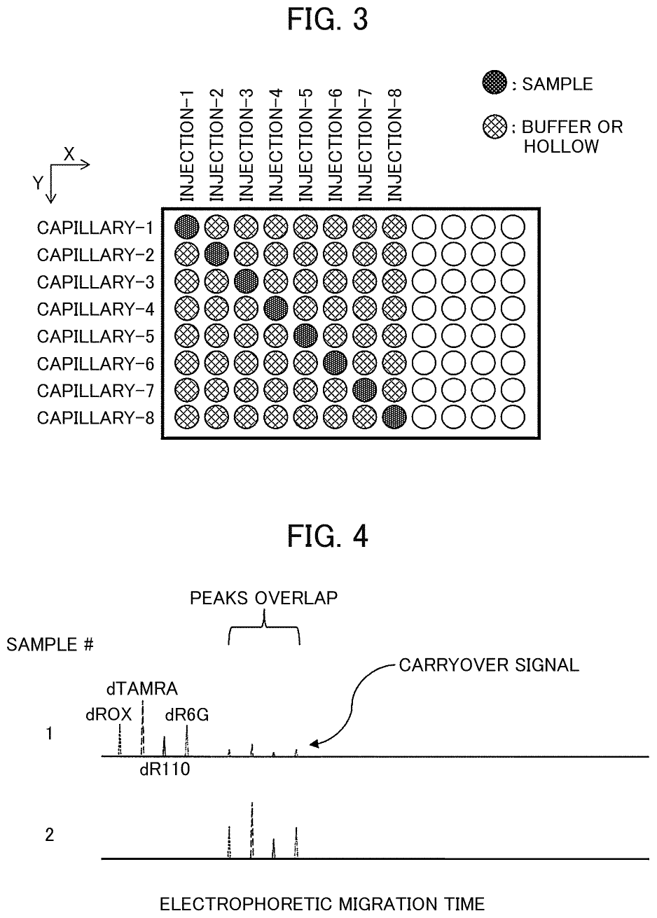

FIG. 3 is a plan view illustrating an exemplary method for suppressing a spatial crosstalk as disclosed in Patent Literature 1. FIG. 3 illustrates that the sample container 124 has 64 wells (8×8) which contain samples and buffers (or hollow parts). Eight capillaries arranged along a Y direction are inserted into the sample container 124 simultaneously so that the sample or the buffer is injected into each capillary (nothing is injected if it is hollow).

The sample is injected into the first capillary (the upper left sample shown in FIG. 3), but is not injected into the second to the eighth capillaries. The sample is injected into the second capillary, but is not injected into the third to the eighth capillaries. As a result, the timing at which the sample component in the first capillary reaches the detection section 116 differs from the timing at which the sample component in the second capillary reaches the detection section 116. This makes it possible to suppress the spatial crosstalk between the capillaries. If the carry-over occurs when using the above-described method, the inconvenience as described below may occur.

FIG. 4 illustrates an example that the peak of the carry-over signal overlaps with the peak of the spatial crosstalk signal on the time axis. The method as indicated by FIG. 3 is implemented on the assumption as described below. The first sample (upper left sample shown in FIG. 3) is introduced into the first capillary to execute electrophoresis for analyzing the sample component. As a result, four signal peaks of the first sample are observed at the left end. The timing for introducing the second sample into the second capillary deviates from the timing for introducing the sample into the first capillary as indicated by a lower section of FIG. 4. Accordingly, the signal peaks derived from the respective capillaries do not overlap with one another on the time axis.

Under the influence of the carry-over upon introduction of the first sample into the first capillary (including the carry-over in the first capillary, the carry-over in the washing container 122), the peak of the carry-over signal may overlap with the peak of the fluorescence signal upon analysis of the sample component using the second capillary on the time axis. If those peaks overlap, the signal peak is likely to be read erroneously, resulting in interference with the accurate component analysis.

FIG. 3 represents an example that each timing for introducing the sample into the respective capillaries is made different among those capillaries. The method for suppressing the spatial crosstalk, however, is not limited to the one as described above. Other methods may be used so long as at least the timing at which the sample component reaches the detection section 116 can be made different among the capillaries from one another. Patent Literature 1 discloses an example that the temperature or concentration of the buffer solution is changed for each well. Even in this case, the problem similar to the one as shown in FIG. 4 may occur.

### First Embodiment: Method for Suppressing Carry-Over

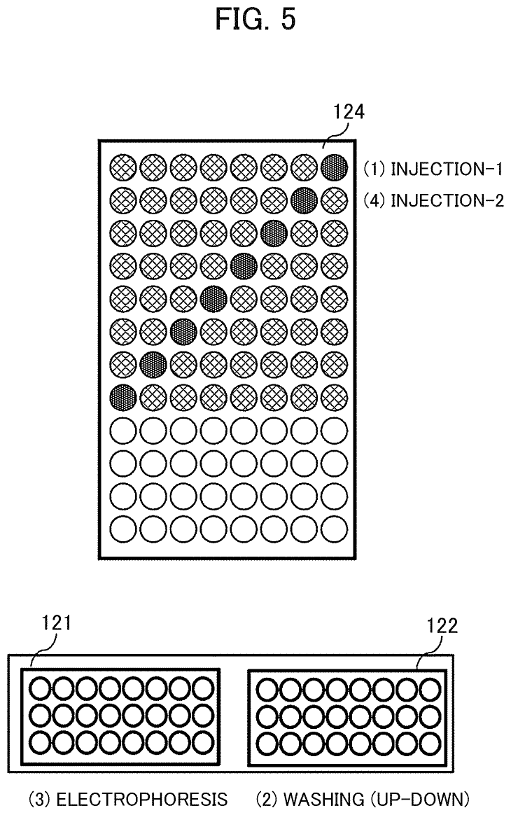

FIG. 5 illustrates a method for suppressing the carry-over as described in a first embodiment. Described herein is an example that the process for suppressing the carry-over is executed when performing the procedure for suppressing the spatial crosstalk as described referring to FIG. 3. Alternatively, it is possible to perform the procedure for suppressing the carry-over through the generally employed measurement procedure without being limited to the example. The specific example is described later.

Referring to an example shown in FIG. 5, the arithmetic operation device 200 controls the stage 130 to introduce the sample into the first capillary ((1)), immerse the end of the first capillary at the sample introduction side in the washing liquid in the washing container 122, and then take the first capillary in/out of the washing container 122 at least one or more times ((2)) until electrophoresis is executed in the first capillary ((3)). The operation for taking the capillary end in/out of the washing liquid is considered to further improve the washing effect compared with mere immersion of the capillary end in the washing liquid. It is thought that the washing effect is improved by removing the residual sample adhered to the lid part for sealing the upper part of the washing container 122 when taking the capillary end out of the washing container 122.

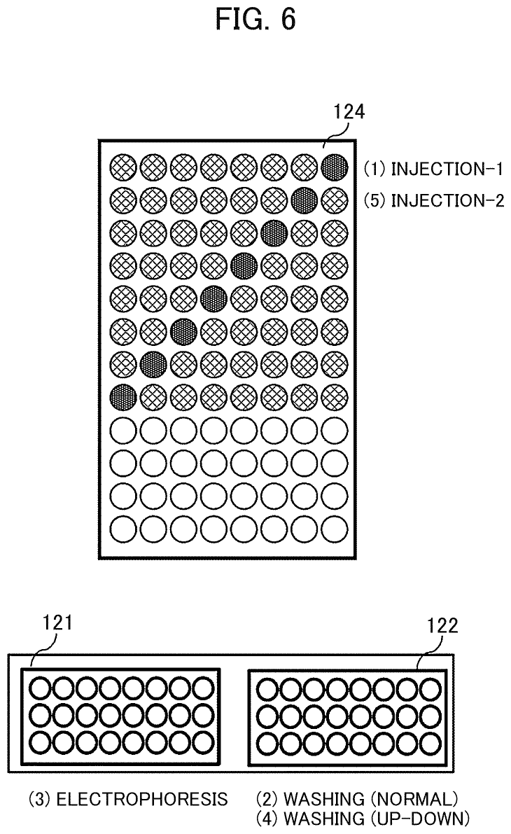

FIG. 6 illustrates another method for suppressing the carry-over as described in the first embodiment. Unlike the case as shown in FIG. 5, in this example, the capillary is taken in/out of the washing liquid immediately after execution of the electrophoresis. Specifically, the method is implemented by the procedure as described below. After introduction of the sample into the first capillary ((1)), the arithmetic operation device 200 washes the end of the first capillary at the sample introduction side by immersion in the washing liquid in the washing container 122 ((2)). Then electrophoresis is executed in the first capillary ((3)). The arithmetic operation device 200 controls the stage 130 to execute electrophoresis in the first capillary, and take the end of the first capillary at the sample introduction side in/out of the washing liquid ((4)) until introduction of the sample into the second capillary ((5)). Like the case as shown in FIG. 5, this makes it possible to effectively wash the capillary.

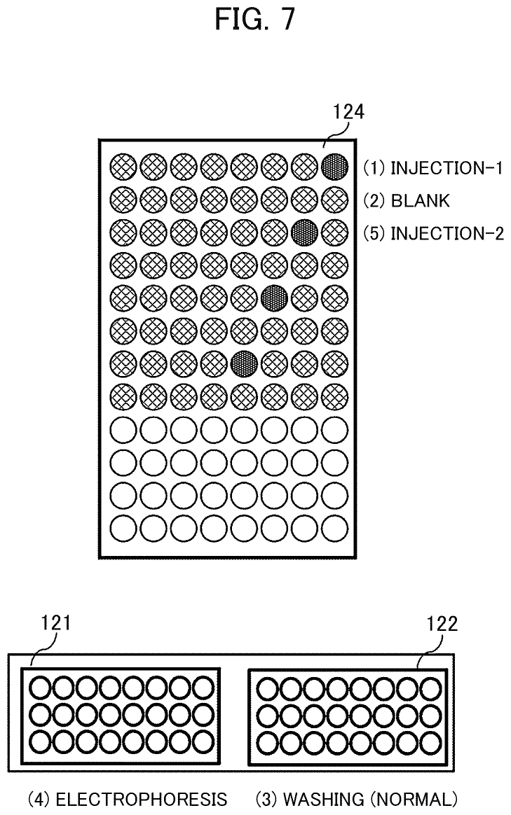

FIG. 7 illustrates another method for suppressing the carry-over as described in the first embodiment. Referring to FIG. 7, the sample container 124 has a row including only one well that stores the sample, while having remaining wells that store no sample, and a row including wells each of which stores the blank sample. Those rows are arranged alternately. The blank sample stands for the liquid contained in the sample container 124, which is not the sample. The position of the well that stores the sample moves leftward by one as advancement of two rows. In this example, the capillary is immersed in the blank sample in addition to immersion in the washing liquid. This makes it possible to improve the washing effect.

Referring to the example shown in FIG. 7, the arithmetic operation device 200 controls the stage 130 to introduce the sample into the first capillary ((1)), and immerse the end of the first capillary at the sample introduction side in the blank sample ((2)) until execution of electrophoresis in the first capillary ((4)). In this example, the arithmetic operation device 200 further controls the stage 130 to immerse the first capillary in the blank sample, and then immerse the end of the first capillary at the sample introduction side in the washing liquid in the washing container 122 until execution of electrophoresis in the first capillary ((4)). The use of the washing liquid and the blank sample allows improvement in the washing effect.

In the case of the example shown in FIG. 7, the sample container 124 which contains the blank sample is not used again. Upon completion of electrophoresis of all the samples in the sample container 124, the blank sample is disposed of together with the sample container 124. Accordingly, unlike the washing container 122, contamination is never accumulated in the blank well. Therefore, it is not essential to take the capillary in/out of the washing container 122 as described referring to FIGS. 5 and 6. As the blank well has to be placed in the sample container 124, the number of the placeable sample wells may be decreased accordingly. On the other hand, the use case that does not use all wells in the sample container 124 hardly causes inconvenience even in the case of using the example shown in FIG. 7. This is useful to attain the washing effect.

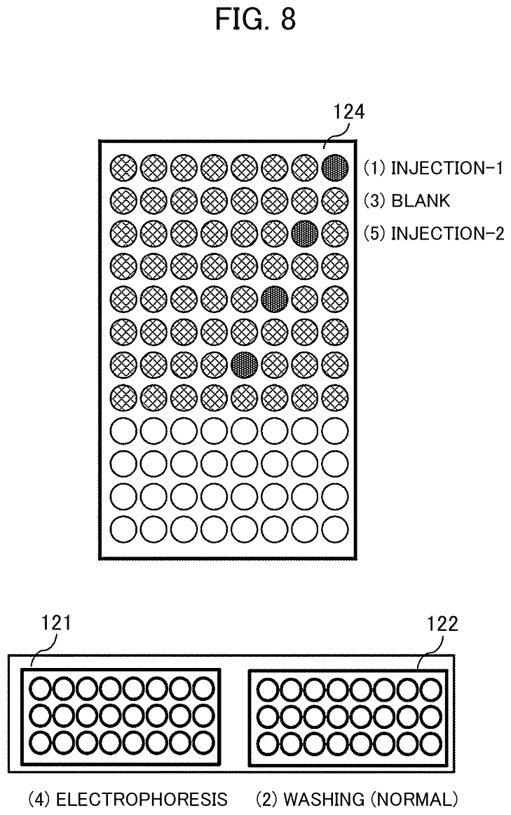

FIG. 8 illustrates another method for suppressing the carry-over as described in the first embodiment. In the procedure as shown in FIG. 8, the order of steps is reversed from the order of steps (2) and (3) as shown in FIG. 7. Specifically, after introducing the sample into the first capillary ((1)), the first capillary is immersed in the washing liquid ((2)). The first capillary is then immersed in the blank sample ((3)). Other steps in the procedure are similar to those described referring to FIG. 7. This procedure also provides the washing effects similar to those described referring to FIG. 7.

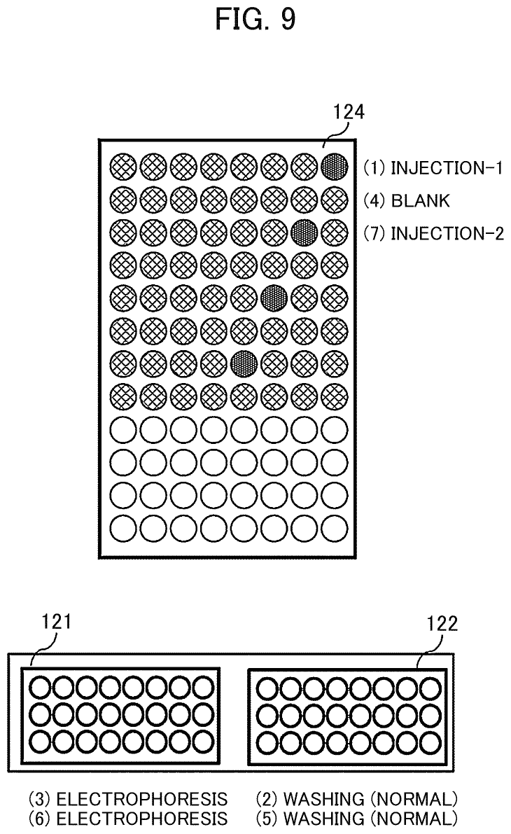

FIG. 9 illustrates another method for suppressing the carry-over as described in the first embodiment. Arrangement of the samples and the blank samples is similar to the one shown in FIGS. 7 and 8. In the example as shown in FIG. 9, for a period of time from electrophoresis using the first capillary ((3)) to electrophoresis using the second capillary ((7)), the arithmetic operation device 200 immerses the first capillary in the blank sample ((4)), and then in the washing liquid ((5)). Electrophoresis is further executed ((6)) to wash away the carry-over component remaining in the first capillary. It is considered that the carry-over can be effectively suppressed before electrophoresis in the second capillary by washing the first capillary using the blank sample and the washing liquid immediately after electrophoresis. Electrophoresis is executed for washing the carry-over component away before electrophoresis in the second capillary. This makes it possible to improve the suppression effect.

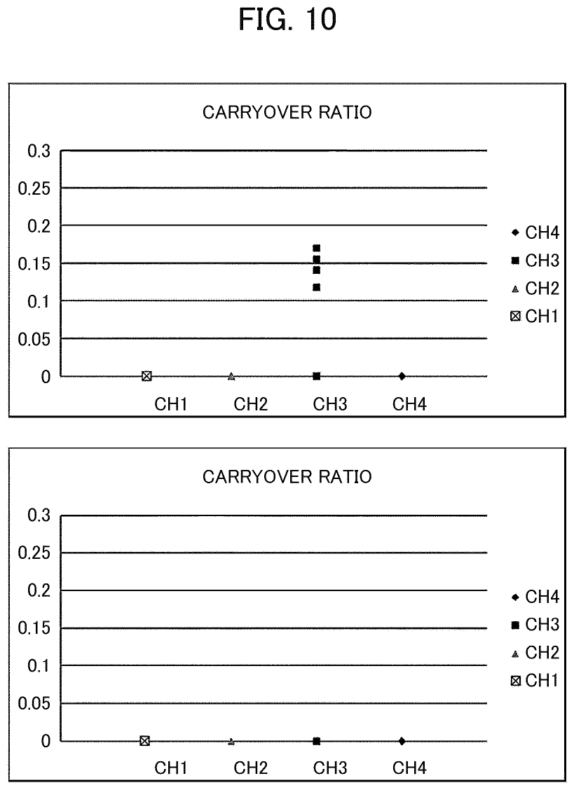

FIG. 10 shows graphs each indicating a verification result with respect to the effect for suppressing the carry-over as described in the first embodiment. An upper graph as shown in FIG. 10 indicates the result of re-measurement of the fluorescence signal peak derived from the capillary which has been electrophoresed, and washed by immersion in the washing liquid. The vertical axis represents the ratio of the carry-over signal peak to the signal peak in electrophoresis. In the example of the upper graph as shown in FIG. 10, the carry-over ratio of the capillary CH3 is approximately 0.2%.

A lower graph as shown in FIG. 10 indicates the result of measurement of the carry-over ratio derived from the procedure as described referring to FIG. 5 under the same conditions as those of the upper graph as shown in FIG. 10. This shows that the carry-over which occurs in the capillary CH3 is reduced to the level below the detection limit value. Accordingly, as the leading end of the capillary is immersed in the washing liquid, and taken in/out as described referring to FIG. 5, the carry-over can be suppressed sufficiently.

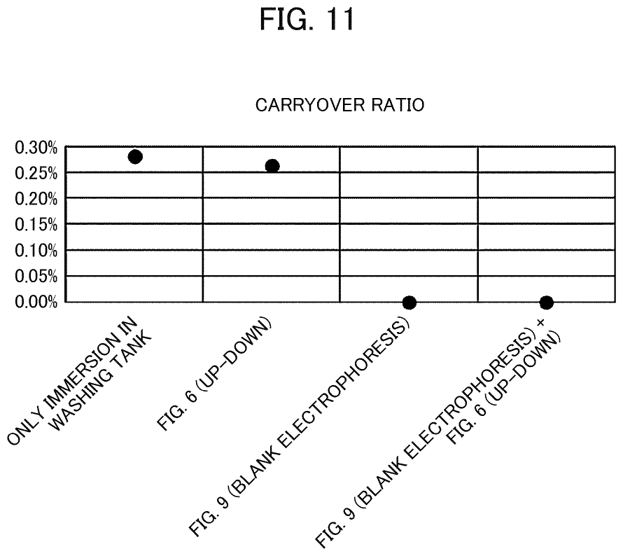

FIG. 11 shows graphs each indicating a verification result with respect to the effect for suppressing the carry-over as described in the first embodiment. In this example, in the cases where the leading end of the capillary is only immersed in the washing liquid (without taking in/out) as generally employed method, and it is only taken in/out as described referring to FIG. 6, the carry-over cannot be suppressed sufficiently. On the contrary, in the cases where washing is performed as described referring to FIG. 9, and the combined washing operation is performed as described referring to FIGS. 9 and 6, it is confirmed that the carry-over can be suppressed to the level below the detection limit value.

### First Embodiment: Summary

The electrophoresis system 1 according to the first embodiment reduces the carry-over from the first sample to the degree that the sample remaining in the washing container 122 after introduction of the sample into the first capillary hardly influences analysis of the sample using the second capillary. Specifically, the stage 130 is controlled to perform operations as described referring to FIGS. 5 to 9. This makes it possible to effectively suppress recurrence of the carry-over as a result of washing of the capillary.

The electrophoresis system 1 according to the first embodiment suppresses the spatial crosstalk by making each timing of the sample signal peaks different among capillaries, and further suppresses the carry-over between the samples by implementing the methods as described referring to FIGS. 5 to 9. This makes it possible to suppress the influence of the carry-over which still remains upon avoidance of the spatial crosstalk as described referring to FIG. 4. This securely attains the effect of suppressing the spatial crosstalk.

### Second Embodiment

In the first embodiment, a plurality of examples have been explained with respect to the method for suppressing the carry-over between the samples. Those procedures can be incorporated into the normal measurement process for measuring the sample component using electrophoresis, or into the calibration process for suppressing the spatial crosstalk as disclosed in Patent Literature 2. In a second embodiment of the disclosure, specific examples of those processes are described.

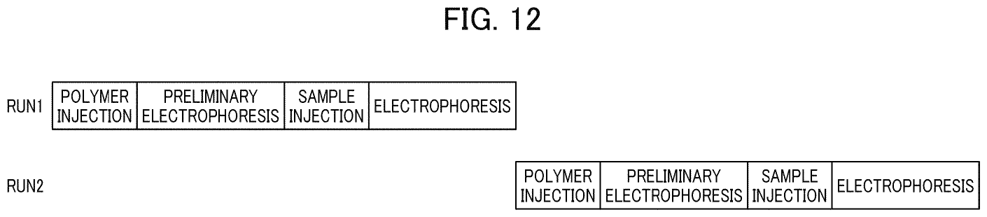

FIG. 12 is a timing chart of the respective processes upon incorporation of the carry-over suppressing procedure into the normal measurement process. The measurement process using the generally employed electrophoresis includes the processes of introducing the separation medium such as the polymer into the capillary, performing a preliminary electrophoresis, introducing the sample into the capillary, and executing electrophoresis. Those four processes in series are executed repeatedly. For a period of time from introduction of the sample into the first capillary to the start of the measurement process using the second capillary (the electrophoresis process of Run 2 as shown in FIG. 12), the procedures as described referring to FIGS. 5 to 9 are executed to allow suppression of the carry-over. For example, the procedure may be executed in the electrophoresis process of Run 1. As the procedures described referring to FIGS. 5 to 9 are executed subsequent to (1) Injection-1, execution of the procedure in the electrophoresis process of Run 1 is common to the respective methods as shown in FIGS. 5 to 9.

The first sample injection process as shown in FIG. 12 corresponds to the (1) Injection-1 as shown in FIGS. 5 to 9. In the next electrophoresis process, steps subsequent to (2) onward as shown in FIGS. 5 to 9 are executed. The process from the step (2) up to the Injection-2 as shown in FIGS. 5 to 9 may be completed at least until start of the second process from polymer injection to sample injection, which corresponds to the Injection-2 as shown in FIGS. 5 to 9.

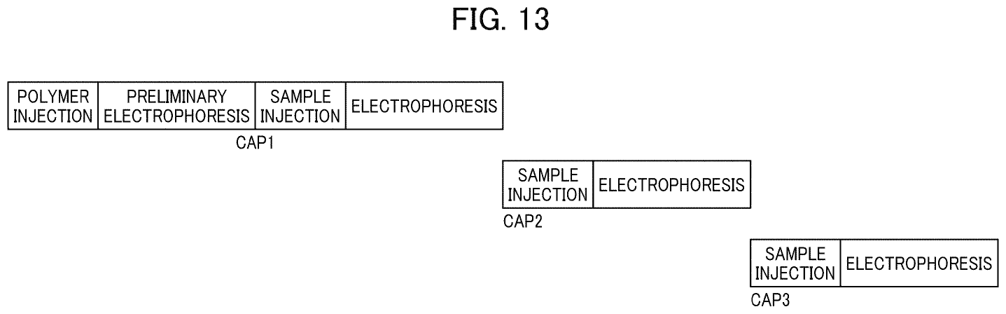

FIG. 13 is a timing chart of the respective processes upon incorporation of the carry-over suppressing procedure into the calibration process for suppressing the spatial crosstalk. In the calibration process as disclosed in Patent Literature 2, the spatial crosstalk is suppressed in the repetitive execution of electrophoresis while advancing the row of the well in the sample container 124 one by one as shown in FIG. 5. As FIG. 13 shows, the operation for introducing the sample in each row into the capillary to execute electrophoresis is repeatedly performed. The calibration process allows implementation of the respective methods as described in the first embodiment. In other words, for a period of time from introduction of the sample into the first capillary to the start of the measurement process using the second capillary (electrophoresis process in Run 2 as shown in FIG. 12), the procedures as described referring to FIGS. 5 to 9 are executed to allow suppression of the carry-over. For example, the suppression process may be executed in the electrophoresis process using the first capillary.

The first sample injection process as shown in FIG. 13 corresponds to (1) Injection-1 as shown in FIGS. 5 to 9. In the next electrophoresis process, steps subsequent to (2) onward as shown in FIGS. 5 to 9 are executed. The process from the step (2) up to the Injection-2 as shown in FIGS. 5 to 9 may be completed at least until start of the second sample injection process corresponding to the Injection-2 as shown in FIGS. 5 to 9.

### Second Embodiment: Summary

As described in the second embodiment, the carry-over suppression procedure of the present disclosure can be performed for (a) each Run while executing the polymer injection to electrophoresis in the normal measurement process, and (b) every sample injection in the calibration process as exemplified in Patent Literature 2. Even if the carry-over suppression process is executed for each Run, the spatial crosstalk may become influential. The carry-over suppression process according to the disclosure is, thus, useful. Even if the calibration is performed for suppressing the spatial crosstalk as described in Patent Literature 2, the little crosstalk may possibly remain. The carry-over suppression procedure according to the disclosure is useful.

### Modification of Disclosure

The present disclosure is not limited to the embodiments as described above, but includes various modifications. For example, the examples described above have been described in detail to simply describe the present disclosure, and are not necessarily required to include all the described configurations. It is possible to replace a part of the structure of one embodiment with the structure of another embodiment. One of embodiments may be provided with an additional structure of another embodiment. It is further possible to add, remove, and replace the other structure to, from and with a part of the structure of the respective embodiments.

In the embodiments, the carry-over does not have to be strictly made 0. The carry-over may be suppressed to the degree that allows measurement of the sample component without hindrance. For example, as for the carry-over upon measurement of the second sample as described referring to FIG. 4, the carry-over may be suppressed to the degree that allows measurement of the sample component by identifying the sample signal peak of the second sample.

In the embodiments, a segment of DNA may be exemplified as the sample to be measured by the electrophoresis apparatus 100 in a non-restrictive manner. The disclosure may be applied to any other samples. The disclosure may be applied to the sample to be quantified through electrophoresis for suppressing the carry-over between samples.

### LIST OF REFERENCE SIGNS

1: electrophoresis system
100: electrophoresis apparatus
122: washing container
124: sample container
130 stage
200: arithmetic operation device

1. An electrophoresis system provided with an electrophoresis apparatus and a computer for controlling the electrophoresis apparatus, wherein
the electrophoresis apparatus includes:
a plurality of capillaries in which electrophoresis of a sample is executed;
a light source for irradiating a detection position of the capillary with a light ray;
a detector for detecting a signal light to be generated dependent on a component of the sample irradiated with the light ray from the light source;
a washing container for containing a washing liquid used for washing a plurality of capillaries; and
a stage for moving the washing container to change a position of the washing container with respect to a plurality of capillaries, and
the computer causes the stage to reduce a carry-over which influences an analysis of the sample using a second capillary out of a plurality of capillaries, the sample remaining in the washing container after introduction into a first capillary out of a plurality of capillaries.

2. The electrophoresis system according to claim 1, wherein
the computer controls the stage to suppress a spatial crosstalk between the first capillary and the second capillary.

3. The electrophoresis system according to claim 2, wherein
the computer suppresses the spatial crosstalk by controlling the stage to make a timing for injecting the sample into the capillary different between the first capillary and the second capillary.

4. The electrophoresis system according to claim 2, wherein
the computer suppresses the spatial crosstalk by controlling the electrophoresis apparatus to make a timing at which the component migrating inside the capillary reaches the detection position different between the first capillary and the second capillary.

5. The electrophoresis system according to claim 2, wherein,
the computer controls the stage to allow a signal peak of a component to be measured in the first capillary to avoid a signal peak of the spatial crosstalk from the second capillary, and
the computer controls the stage to reduce the carry-over from the first capillary to the degree that the signal peak of the spatial crosstalk from the second capillary becomes identifiable.

6. The electrophoresis system according to claim 1, wherein,
the electrophoresis apparatus further includes a washing bath which contains the washing liquid, and
the computer reduces the carry-over by controlling the stage to take an end of the first capillary in/out of the washing bath for a period of time from injection of the sample into the first capillary to execution of electrophoresis in the first capillary.

7. The electrophoresis system according to claim 1, wherein,
the electrophoresis apparatus further includes a washing bath which contains the washing liquid, and
the computer reduces the carry-over by controlling the stage to take an end of the first capillary in/out of the washing bath for a period of time from execution of electrophoresis in the first capillary to injection of the sample into the second capillary.

8. The electrophoresis system according to claim 1, wherein,
the electrophoresis apparatus further includes a blank container which contains a blank sample, and
the computer reduces the carry-over by controlling the stage to immerse an end of the first capillary into the blank sample for a period of time from injection of the sample into the first capillary to execution of electrophoresis in the first capillary.

9. The electrophoresis system according to claim 8, wherein,
the electrophoresis apparatus further includes a washing bath which contains the washing liquid, and
the computer controls the stage to immerse the end of the first capillary in the washing liquid for a period of time from immersion of the first capillary into the blank sample to execution of electrophoresis in the first capillary.

10. The electrophoresis system according to claim 8, wherein,
the electrophoresis apparatus further includes a washing bath which stores the washing liquid, and
the computer controls the stage to immerse the end of the first capillary in the washing liquid for a period of time from injection of the sample into the first capillary to immersion of the end of the first capillary in the blank sample.

11. The electrophoresis system according to claim 1, wherein,
the electrophoresis apparatus further includes a blank container which contains a blank sample, and a washing bath which contains the washing liquid, and
the computer controls the stage to:
immerse an end of the first capillary in the blank sample;
immerse the end of the first capillary in the washing liquid; and
wash the sample remaining in the first capillary away by executing electrophoresis in the first capillary
for a period of time from execution of electrophoresis in the first capillary to execution of subsequent electrophoresis in the second capillary.

12. The electrophoresis system according to claim 1, wherein
the computer causes the stage to perform an operation to reduce the carry-over during a process for measuring the sample using the capillary.

13. The electrophoresis system according to claim 1, wherein
the computer causes the stage to perform an operation to reduce the carry-over during a calibration process before measurement of the sample using the capillary.
